(19) United States
(12) Patent Application Publication
(10) Pub. No.: US 2026/0021875 A1
(43) Pub. Date: Jan. 22, 2026

(54) A FLOATING SOLAR PHOTOVOLTAIC SYSTEM

(71) Applicant: SOLARMARINE ENERGY LTD, Ballina, Co. Mayo (IE)

(72) Inventors: Eamon HOWLIN, Ballina, Co. Mayo (IE); Jonathan HANCOCK, Sparti (GR); Marco ROSA-CLOT, San Giuliano Terme (IT)

(21) Appl. No.: 18/998,774

(22) PCT Filed: Jul. 25, 2023
(86) PCT No.: PCT/EP2023/070572

§ 371 Date: Jan. 27, 2025

(30) Foreign Application Priority Data
Jul. 27, 2022 (GB) 2210947.4

(51) Int. Cl. B63B 35/44; B63B 21/50

(52) U.S. Cl. CPC B63B 35/44; B63B 21/50; B63B 2035/442; B63B 2035/4453

(57) ABSTRACT

A floating photovoltaic system (1) comprising a flotation unit (100) and a mooring system (30), wherein the flotation unit (100) comprises at least one sail (2) having at least one vertical or near vertical photovoltaic panel (20) mounted on a mast (3) and supported on a base (5), wherein the base (5) further comprises at least one buoyancy element (10); and wherein the mooring system (30) comprises a single point mooring buoy (32) connected to at least one buoyancy element (10) or the base (5) via mooring lines (33), and at least one mooring line (34) from the single point mooring buoy (32) tethered to at least one anchor point (36).

### FIELD OF THE INVENTION

The invention relates to a solar panel for harvesting renewable energy. Specifically, the invention relates to solar panels that are located on a body of water attached to a floating structure.

### BACKGROUND TO THE INVENTION

Conventional in-shore floating solar platforms cannot cope with large wave heights efficiently, as they do not have the ability to shed environmental loads (e.g., by using a weathervane mooring). Bird droppings, biofouling and dust/dirt are all major issues with conventional floating solar panel platforms. Conventional spread moored solar arrays have a large mooring footprint and often use many perimeter mooring lines which leads to inefficient non-even load distribution between moorings which can also be a major cause of mooring failure.

Existing photovoltaic (PV) panel configurations on floating structures do not maximise the capture of diffuse light. In northern latitudes (40° and higher), the amount of diffuse light available can exceed the amount of global horizontal irradiance available. Existing horizontally configured floating PV panels cannot capture diffuse light efficiently at these latitudes.

The problems facing current floating solar arrays are that they are limited to relatively benign conditions (typically inshore or occasionally near shore with low wave heights); dust or dirt buildup and bird droppings and biofouling reduce panel efficiency and require extensive cleaning and/or bird scaring and/or bird deterrent systems; conventionally moored floating solar arrays have a large mooring footprint and a large number of mooring lines which makes even load share between the moorings difficult, reducing the efficiency and reliability of the mooring system, and the multiple mooring lines and anchors have negative effects on the seabed; and conventional horizontally mounted PV panels either one sided or bifacial, do not capture the maximum amount of diffuse light available.

Some of these problems have been attempted to be solved. For example, US2017040926A1 appears to disclose a floating solar array comprising solar panels where the array has mooring lines and anchoring points with an active rotating tracking system that both tracks the path of the sun and that has to work against the environmental forces to ensure the panels are positioned to face the dominant direction of the sun, and has a membrane to reduce wave motion on the array. However,—the active mooring system that enables vertical axis tracking completely ignores the prevailing wind and sea direction and does not attempt to reduce environmental loads. This will result in ‘swamping’/overtopping of the floating PV panel support structure in relatively low sea states whilst the near horizontal PV panels can pick up maximum wind loads. The addition of the stabilising skirt will further increase the likelihood of ‘swamping’ (submergence of the outer rows of panels) in high wind and running sea conditions.

US2016141437A1 appears to describe a photovoltaic system which may be mounted on floating bodies and may have at least two bifacial solar module holders vertically positioned to utilise the Albedo effect and are preferably oriented in a north-south (N/S) direction so that the front and rear sides of the solar modules are oriented towards east or west. However, the fixed N/S vertical panels will attract large wind and wave loads necessitating heavy extensive moorings to keep the array facing the proposed N/S direction and an extremely robust PV Panel steel support structure. There is also a very high likelihood that the floating PV array will be swamped by waves as it tries to survive adverse weather and rough sea conditions. The system does not attempt to reduce wind and wave loads.

It is an object of the present invention to overcome at least one of the above-mentioned problems.

### SUMMARY OF THE INVENTION

The invention relates to the use of vertical or near-vertical solar panels (PV or thermal panels) on a floating structure with a mooring system which enables the structure to rotate (for example, like a weathervane) to minimize or shed environmental loads (including wind, wave, and current). The floating structure is formed of multiple interconnected units with rotating joints enabling large arrays to be formed which can adapt to the wave profile reducing loads. The solar panels are mounted vertically or near-vertically either using bifacial panels or simply back-to-back solar panels. This arrangement maximises the capture of diffuse light and capitalises on the Albedo effect (light reflecting off water) because of the open frame structural design, this also has a positive environmental effect as the water is not completely blocked from receiving light. Vertical or near-vertical solar panels reduce maintenance and cleaning requirements as birds will not have a large horizontal area to land on, plus the small area available for landing on top of the vertical solar panels can have bird deterrent features such as vertical cable ties or vertical plastic strips, and rainfall will help to clean the panels through gravity-induced rain/water run-off, and the solar panels can easily be positioned above the water, thereby increasing the freeboard, and decreasing the risk of wave loads on the solar panels.

There is provided, as set out in the appended claims, a floating solar panel system (1) comprising a flotation unit (100) and a mooring system (30), wherein the flotation unit (100) comprises at least one sail (2) having at least one vertical or near vertical photovoltaic panel (20) mounted on a mast (3) and supported on a base (5), wherein the base (5) further comprises at least one buoyancy element (10); and wherein the mooring system (30) comprises a single point mooring buoy (32) connected to the at least one buoyancy element (10) or the base (5), and at least one mooring line (34) from the mooring buoy (32) tethered to at least one anchor point (36).

In one aspect, the mooring system (30) comprises at least two or at least three mooring lines (34) tethered to the at least one anchor point (36).

In one aspect, there is one anchor point (36) for each mooring line (34).

In one aspect, the mooring system allows the flotation unit (100) to rotate about the single point mooring buoy (32).

In one aspect, the at least one vertical or near vertical photovoltaic panel (20) is aligned to be in-line with a downwind direction of the single point mooring buoy (32).

In one aspect, two or more flotation units can be connected together via a horizontal element (8). Preferably, the horizontal element (8) connects to the two or more flotation units (100) via a flexible joint (9) at either end of the horizontal element (8).

In one aspect, the horizontal element (8) (or the base (5)) is composed of a material selected from galvanised steel, stainless steel, polypropylene, polyethylene (PE), polyethylene terephthalate copolymer (PETG), amorphous polyethylene terephthalate (APET), polyvinyl chloride (PVC), steel, steel coated with a corrosion resistant coating, galvanized steel, aluminium, titanium, fibre reinforced polymer (FRP), concrete, reinforced concrete with or without prestressed elements, syntactic foam, or composite materials.

In one aspect, the horizontal element (8) has an open frame structure to allow light to pass between the sail (2) and a water surface.

In one aspect, the floating solar panel system (1) further comprises at least one buoyancy element (10) connected to the base (5). Preferably, the at least one buoyancy element (10) is positioned to align with a down wave direction of the single point mooring buoy (32). Preferably, the at least one buoyancy element (10) is a type selected from a horizontal shaped element, a circular shaped element, a SPAR-shaped element, a box shaped element, or a flat raft-type element, a single or multiple pipe element, a semi-submersible element, other elongated buoyancy shaped elements.

In one aspect, the photovoltaic panels (20) are monofacial or bifacial, or a combination thereof.

In one aspect, the floating solar panel system (1) can have a mixture of photovoltaic and thermal panels, which can be either monofacial, bifacial, or a mixture thereof.

In one aspect, there is provided an array (200) comprising a plurality of the flotation units (100) described above joined together by a horizontal element(s) (8) via a flexible joint (9) at either end of the horizontal element (8).

In one aspect, the array (200) further comprises a reflective or a non-reflective material stretched over the horizontal element (8).

In one aspect, there is provided a method of generating solar energy, the method comprising placing the floating solar panel system (1) described above on a body of water, securing the system (1) to a single point mooring buoy (32), and securing the single point mooring buoy (32) with at least one mooring line (34) that is also tethered to at least one anchor point (36).

In one aspect, the solar panel system (1) is further connected a battery, a cable connected to the national grid, a cable connected to a standalone micro-grid, a cable connected to a subsea oil and/or gas asset, a cable connected to a subsea datacentre, a cable connected to an offshore charging station, a cable connected to an offshore platform, a cable connected to a desalination plant, a cable connected to a hydrogen electrolyser, a cable connected to shoreside buildings in conjunction with battery banks, grid mains electricity, or both; or a cable connected to an offshore wind turbine or an offshore transformer station, or both.

In one embodiment, the material of construction of the system is suitably a durable yet rigid material, for example stainless steel, polypropylene, polyethylene (PE), polyethylene terephthalate copolymer (PETG), amorphous polyethylene terephthalate (APET), polyvinyl chloride (PVC), steel, steel coated with a corrosion resistant coating (for example, galvanized steel and steel with marine grade paint/coating systems), aluminium, titanium, fibre reinforced polymer (FRP) (for example, glass and/or carbon fibre composites), concrete, reinforced concrete with or without prestressed elements, syntactic foam, and the like.

### DEFINITIONS

In the specification, the term “solar panel” or “solar panel system” should be understood to mean an assembly of solar cells mounted in a framework for installation. Photovoltaic (PV) solar cells or panels use sunlight as a source of energy and generate direct current electricity. Thermal solar cells or panels absorb solar radiation and then transfer it in the form of thermal energy to heat a fluid (as opposed to creating electrical energy). A collection of PV solar cells is called a PV Panel (or a Sail). A plurality of sails is an array. Arrays of a PV system supply solar electricity to electrical equipment. Solar panels can accept light from one side (unifacial or monofacial) or accept light from both sides (bifacial).

In the specification, the term “near-vertical” should be understood to mean being at an angle of at least 60° but no more than 120° relative to the horizontal plane parallel to still water level.

In the specification, the term “passive mooring system” should be understood to mean a mooring system that does not use a powered or active mooring system that works against environmental loads (wind, waves, and current) but rather has a mooring system configured geometrically such that the force from the environmental loads automatically aligns the floating structure so that the environmental loads are minimised.

In the specification, the term “single point mooring buoy” should be understood to mean a floating structure moored to a single mooring point or buoy.

In the definition, the term “reflective” should be understood to mean a material which is capable of reflecting light or other radiation. Examples of materials that can be used with the claimed invention and which are reflective include, silver, aluminium, reflective aluminium, a mirror, white card or plastic.

In the specification, the term “non-reflective” should be understood to mean a material which is not capable of reflecting light. Examples of such materials include non-reflective glass, black foil, Vantablack® (a class of super-black coatings with total hemispherical reflectance (THR) below 1.5% in the visible spectrum) and wood.

In the specification, the term “SPAR buoyancy element” or “SPAR buoy” should be understood to mean a tall, thin buoy that floats upright in the water and is characterized by a small water plane area and a large mass. Spar buoys are often used as stable platforms for oil and gas production, wave measurement devices and air-sea interaction measurements.

In the specification, the term “buoyancy element” should be understood to mean a floating object that can support the weight of another object and a “buoy” should be understood to mean a single floating object typically of a spherical or rounded shape.

In the specification, the term “still water level” should be understood to mean the average water surface elevation at any instant, excluding local variation due to waves and wave set-up.

In the specification, the term “downwind” should be understood to mean situated or moving in the direction in which the wind is blowing to.

In the specification, the term “down wave” should be understood to mean situated or moving in the direction which the waves are going to.

### BRIEF DESCRIPTION OF THE DRAWINGS

The invention will be more clearly understood from the following description of an embodiment thereof, given by way of example only, with reference to the accompanying drawings, in which:—

FIG. 1 illustrates an end view of one aspect of the floating photovoltaic system of the claimed invention.

FIG. 2 illustrates a side view of the floating photovoltaic system as shown in FIG. 1.

FIG. 3 illustrates a perspective view of the floating photovoltaic system as shown in FIGS. 1 and 2.

FIG. 4 is a plan view of the floating photovoltaic system as shown in FIGS. 1 to 3 with the passive mooring system illustrated. The system weathervanes about a mooring buoy. The circles show the approximate ‘watch circle’ of the system and mooring anchor footprint.

### DETAILED DESCRIPTION OF THE DRAWINGS

### Materials and Methods

Solar panels can be PV or thermal solar panels. The floating structure is made of materials suitable for the marine (fresh and/or salt water) environment which includes metallic materials (either corrosion resistant alloys or non-corrosion resistant metals with an appropriate coating system and/or cathodic protection system), polymer materials, HDPE, fibre reinforced polymer materials, and the like.

A test using ˜1:10 scale model of a small array of 4 sails described herein in a wave-generating and wind-generating water tank with horizontal lines affixed thereto that simulate the mooring lines going to a mooring buoy. Tests were performed under different wind and wave conditions.

### Results

The tests using the scale model (circa 1:10 scale) under different wind and wave conditions demonstrated the weathervane motion of the system when subjected to wind and waves. The tests also demonstrated that the use of flexible joints attaching the flotation units together in an array adapt to the wave profile, further reducing structural loads from the wave action by adapting to the wave profile rather than remaining rigid and resisting the vertical wave forces structurally. The individual flotation units within the array are free to rotate (pitch and roll) and heave (up-down) but are fixed relative to each other in surge, sway, and yaw. This means that the sails of the flotation units cannot clash with each other as they are restrained in surge, sway, and yaw, but also that the structural force in the array is minimized if the individual flotation units are free to move in pitch, roll, and heave (this means they adapt to or follow the wave profile).

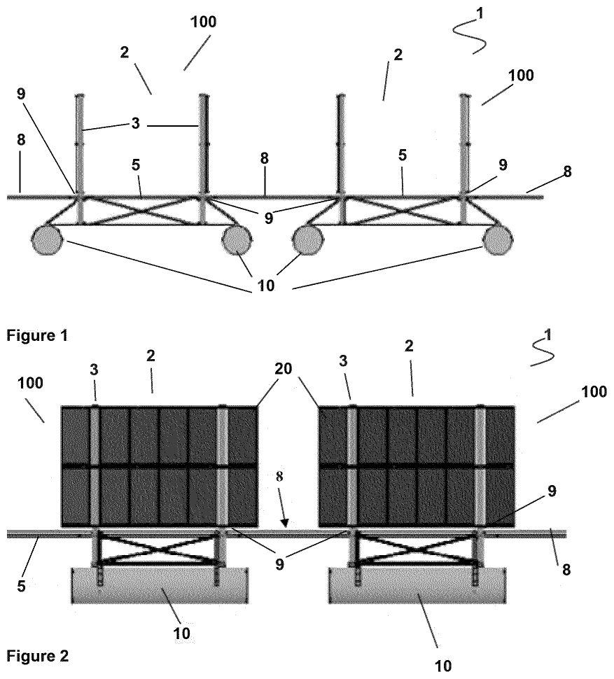

Referring now to the figures, where FIG. 1 illustrates a general embodiment of a floating photovoltaic (PV) system of the present invention. Specifically, FIG. 1 illustrates an end view of a system of the present invention and is generally referred to by reference numeral 1. The system 1 of the illustrated embodiment comprises at least one flotation unit 100 having at least one sail 2 comprising at least one vertical or near-vertical mast 3, each mast 3 configured to accommodate at least one photovoltaic panel 20, and a base 5. The base 5 is configured to accommodate at least one photovoltaic panel 20. The base 5 further comprises at least one buoyancy element 10 positioned beneath the base 5. The buoyancy element 10 shown in the Figures is a pair of twin horizontal pipe elements. Other buoyancy configurations that could be used include buoyancy element(s) of various shapes or SPAR-type buoyancy elements, a flat raft type structure, a single or multiple pipe structure, a semi-submersible type structure, of which all could also be used. The photovoltaic panels 20 can be monofacial and mounted back-to-back, or the photovoltaic panels 20 can be bifacial.

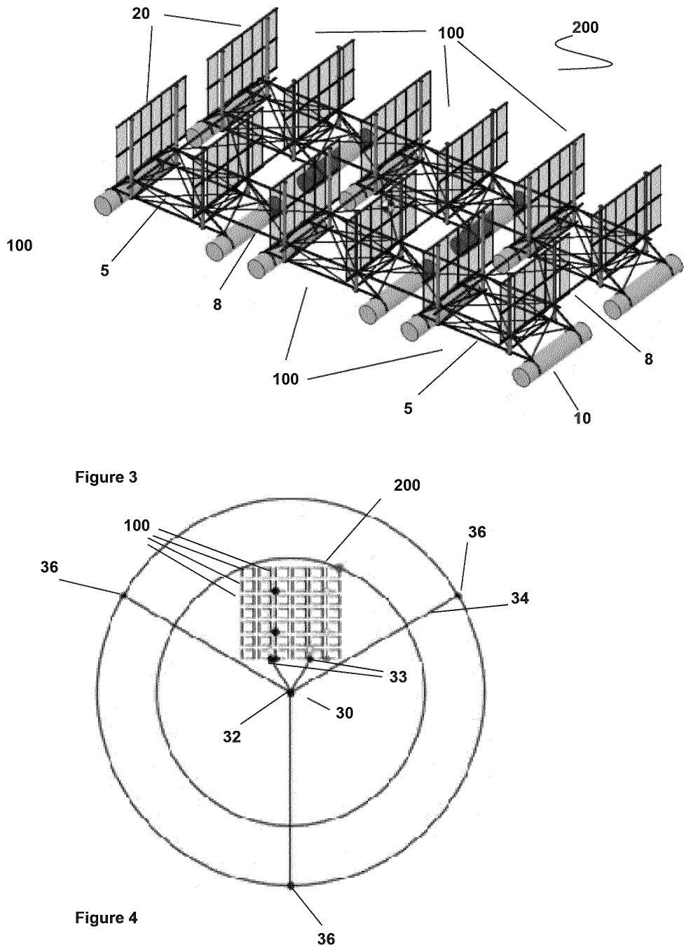

As can be seen from FIGS. 2 and 3, the floating photovoltaic system 1 comprises a plurality of flotation units 100 spaced apart from each other, forming an array of flotation units 100. The flotation units 100 are linked together by horizontal elements 8 which connect the individual bases 5 together. These linking horizontal elements 8 fall within approximately the same horizontal plane as each other and are parallel to the still water level. The linking horizontal elements 8 are connected to the bases 5 by flexible joints 9 at either end of each horizontal element 8. The horizontal elements 8 and the space between the sails 2 can be made from reflective or non-reflective material.

The array of flotation units 100 are tethered to a mooring system 30 (see FIG. 4). The mooring system 30 comprises a single point mooring buoy 32 connected to the array of flotation units 100 at a point 33, and coupled to one or more mooring lines 34 that are tethered to at least one anchor point 36. The at least one anchor point 36 can be on land or on the seabed.

The single point mooring buoy 32 is positioned at a single point relative to the array of flotation units 100. This configuration means that the array of flotation units 100 can rotate around the single point mooring buoy 32, that is, it enables the weathervane motion of the array of flotation units 100. Mooring configurations with multiple surface buoys at different points around the array of flotation units 100 would restrain the rotational motion of the array of the flotation units 100, preventing the weathervane motion. The motion of the array of flotation units 100 is caused by the environmental loads (e.g., wind and wave loads), and the geometric configuration of the mooring system 30. This allows free rotation of the array of flotation units 100 about a single point (the single point mooring buoy 32), which is offset from the centre of the array of flotation units 100, and results in the array of flotation units 100 automatically or passively rotating downwind or down wave of the single point mooring buoy 32. The alignment of the vertical or near-vertical sails 2 on the array structure is set to be in-line with the downwind direction of the single point mooring buoy 32, ensuring that the sails 2 are “edge on” to the wind, which reduces wind loads. Buoyancy elements 10 at the base 5 of the system 1 can also be positioned so that they align with the “down wave” direction of the single point mooring buoy 32. This reduces wave loads by minimizing the area of the buoyancy elements 10 exposed to the oncoming waves by ensuring the smaller end area of the buoyancy elements 10 point towards the oncoming waves, for example, by ensuring the buoyancy element 10 is “bow on” to the waves for shaped buoyancy elements or “end on” for horizontal pipe-shaped buoyancy elements.

### Discussion

The advantages of the floating vertical or near-vertical solar panel system 1 are that having high wind loads from one direction (perpendicular to panels), with very low wind loads from the opposite direction (end on to panels), combining this with a weathervane (passive) mooring system 30 enables the system 1 to provide reduced environmental loads on the panels 20. When using long and thin buoyancy elements 10 with the weathervane mooring system 30, they also provide a strongly directional dependent load (wave and current) characteristic (low loads end-on, higher loads perpendicular), which reduces wave and current loads. The panels 20 can easily be raised upwards away from the water surface (increasing the freeboard) to reduce the possibility of wave loads on the panels 20.

The use of vertical or near vertical panels 20 with the system 1 drastically reduces panel cleaning requirements as there is reduced dust, dirt, bird droppings, and biofouling on the vertical or near-vertical panels 20, which is often a major issue for conventional floating solar arrays that have horizontal or near horizontal panels.

The use of an efficient mooring system enables a simpler, more reliable mooring. The mooring footprint can also be reduced compared to a conventional spread moored system as the floating solar photovoltaic system 1 of the claimed invention can float over the mooring lines 34 of the mooring system 30.

The vertical or near-vertical photovoltaic panels 20 can be mounted back-to-back or they can be bifacial panels, which capture the maximum amount of diffuse light available and also benefits from light reflected from the water surface.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail.

1. A floating solar panel system (1) comprising a flotation unit (100) and a mooring system (30), wherein the flotation unit (100) comprises at least one sail (2) having at least one vertical or near vertical photovoltaic panel (20) mounted on a mast (3) and supported on a base (5), wherein the base (5) further comprises at least one buoyancy element (10); and wherein the mooring system (30) comprises a single point mooring buoy (32) connected to the at least one buoyancy element (10) or to the base (5), and at least one mooring line (34) from the single point mooring buoy (32) tethered to at least one anchor point (36).

2. The floating solar panel system (1) according to claim 1, wherein the mooring system (30) comprises at least two or at least three mooring lines (34) tethered to the at least one anchor point (36).

3. The floating solar panel system (1) according to claim 1 or claim 2, wherein there is one anchor point (36) for each mooring line (34).

4. The floating solar panel system (1) according to any one of the preceding claims, wherein the mooring system allows the flotation unit (100) to rotate about the single point mooring buoy (32).

5. The floating solar panel system (1) according to anyone of the preceding claims, wherein the at least one vertical or near vertical photovoltaic panel (20) is aligned to be in-line with a downwind direction of the single point mooring buoy (32).

6. The floating solar panel system (1) according to any one of the preceding claims, wherein two or more flotation units can be connected together via a horizontal element (8).

7. The floating solar panel system (1) according to claim 6, wherein the horizontal element (8) connects to the two or more flotation units (100) via a flexible joint (9) at either end of the horizontal element (8).

8. The floating solar panel system (1) according to claim 6 or claim 7, wherein the horizontal element (8) or the base (5) is composed from a material selected from galvanised steel, stainless steel, polypropylene, polyethylene, polyethylene terephthalate copolymer, amorphous polyethylene terephthalate, polyvinyl chloride, steel, steel coated with a corrosion resistant coating, galvanized steel, aluminium, titanium, fibre reinforced polymer, concrete, reinforced concrete with or without prestressed elements, syntactic foam, or composite materials.

9. The floating solar panel system (1) according to any one of claims 6 to 8, wherein the horizontal element (8) has an open frame structure to allow light to pass between the sail (2) and a water surface.

10. The floating solar panel system (1) according to any one of the preceding claims, wherein the at least one buoyancy element (10) is connected to the base (5).

11. The floating solar panel system (1) according to claim 10, wherein the at least one buoyancy element (10) is positioned to align with a down wave direction of the single point mooring buoy (32).

12. The floating solar panel system (1) according to claim 10 or claim 11, wherein the at least one buoyancy element (10) is a type selected from a horizontal shaped element, a circular shaped element, a SPAR-shaped element, a box shaped element, or a flat raft-type element, a single or multiple pipe element, a semi-submersible element, and other elongated buoyancy shaped elements.

13. The floating solar panel system (1) according to anyone of the preceding claims, wherein the photovoltaic panels (20) are monofacial or bifacial, or a combination thereof.

14. An array (200) comprising a plurality of the flotation units (100) of claim 1 joined together by a horizontal element(s) (8) via a flexible joint (9) at either end of the horizontal element (8).

15. The array (200) of claim 14, further comprising a reflective or a non-reflective material stretched over the horizontal element (8).

16. A method of generating solar energy, the method comprising placing the floating solar panel system (1) of claim 1 on a body of water, securing the system (1) to the single point mooring buoy (32), and securing the single point mooring buoy (32) with the at least one mooring line (34) that is also tethered to the at least one anchor point (36).

17. The method of claim 16, wherein the solar panel system (1) is further connected a battery, a cable connected to the national grid, a cable connected to a standalone micro-grid, a cable connected to a subsea oil and/or gas asset, a cable connected to a subsea datacentre, a cable connected to an offshore charging station, a cable connected to an offshore platform, a cable connected to a desalination plant, a cable connected to a hydrogen electrolyser, a cable connected to shoreside buildings in conjunction with battery banks, grid mains electricity, or both; or a cable connected to an offshore wind turbine or a cable connected to an offshore transformer station, or both.

18. The method of claim 16 or claim 17, wherein the material of construction of the system (1) is selected from a durable yet rigid material, for example stainless steel, polypropylene, polyethylene, polyethylene terephthalate copolymer, amorphous polyethylene terephthalate, polyvinyl chloride, steel, steel coated with a corrosion resistant coating, aluminium, titanium, fibre reinforced polymer, concrete, reinforced concrete with or without prestressed elements, syntactic foam, and the like.
